(19) United States
(12) Patent Application Publication
(10) Pub. No.: US 2024/0109249 A1
(43) Pub. Date: Apr. 4, 2024

(54) 3D Printer for Continuous Carbon Fibers

(71) Applicant: BOARD OF TRUSTEES OF THE UNIVERSITY OF ARKANSAS, Fayetteville, AR (US)

(72) Inventors: Wenchao Zhou, Springdale, AR (US); Yadong Chen, Fayetteville, AR (US)

(73) Assignee: BOARD OF TRUSTEES OF THE UNIVERSITY OF ARKANSAS, Fayetteville, AR (US)

(21) Appl. No.: 18/539,197

(22) Filed: Dec. 13, 2023

Related U.S. Application Data
(62) Division of application No. 17/404,951, filed on Aug. 17, 2021, now abandoned.
(60) Provisional application No. 63/067,792, filed on Aug. 19, 2020.

(51) Int. Cl. B29C 64/209; B29C 64/141; B33Y 10/00; B33Y 30/00

(52) U.S. Cl. CPC B29C 64/209; B29C 64/141; B33Y 10/00; B33Y 30/00; B29K 2307/04

(57) ABSTRACT

A 3D printer for printing continuous carbon fibers comprising a mechanical system and control system.

### RELATED APPLICATIONS

This application claims priority to U.S. Provisional Application No. 63/067,792, filed on Aug. 19, 2020, which is incorporated herein in its entirety

### STATEMENT REGARDING FEDERALLY SPONSORED RESEARCH & DEVELOPMENT

Not applicable.

### INCORPORATION BY REFERENCE OF MATERIAL SUBMITTED ON A COMPACT DISC

Not applicable.

### BACKGROUND OF THE INVENTION

Carbon fiber is a wonder material that makes everything lighter and stronger. Being able to 3D print carbon fiber will enable a wide variety of applications in many industries, such as aerospace and automobile. The current 3D printers, however, mostly print with filaments reinforced with chopped carbon fibers, where most of the strength is lost. Continuous carbon fiber, which retains the strength of carbon fibers, has long been used to construct aerospace structures using expensive techniques such as automated fiber placement (AFP), which remains to be inaccessible to common engineering applications due to cost.

### BRIEF SUMMARY OF THE INVENTION

In one embodiment, the present invention provides a 3D printer for continuous carbon fibers without complex and expensive robot arm and systems used in AFP. The printer is built uses a Fused Deposition Modeling (FDM) printer with a specially designed printhead for pre-impregnated continuous carbon fiber tapes.

In other embodiments, the present invention provides a method and a system for 3D printing of pre-impregnated continuous carbon fiber tapes by using a FDM 3D printer that enables 3D printing pre-impregnated continuous carbon fiber tapes as printing material.

In other embodiments, the present invention provides a method and a system for printing 3D carbon fiber structures.

In other embodiments, the present invention provides a slicer add-on that can automatically generate appropriate additional G-code for controlling printing direction, cutting, and heating for different geometric models.

In other embodiments, the present invention provides a method and a system for Swarm 3D Printing with Continuous Carbon Fiber Tape.

In other embodiments, the present invention provides a method and a system for mounting on a mobile printing robot to print together with other mobile 3D printers for hybrid printing and manufacturing.

It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

In the drawings, which are not necessarily drawn to scale, like numerals may describe substantially similar components throughout the several views. Like numerals having different letter suffixes may represent different instances of substantially similar components. The drawings illustrate generally, by way of example, but not by way of limitation, a detailed description of certain embodiments discussed in the present document.

FIG. 1 illustrates an embodiment of the present invention.

FIG. 2 illustrates a carbon fiber tape extruder that may be used with the embodiment shown in FIG. 1.

FIG. 3 depicts an exemplary carbon fiber segment extrude by the embodiment shown in FIG. 1.

### DETAILED DESCRIPTION OF THE INVENTION

Detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a representative basis for teaching one skilled in the art to variously employ the present invention in virtually any appropriately detailed method, structure or system. Further, the terms and phrases used herein are not intended to be limiting, but rather to provide an understandable description of the invention.

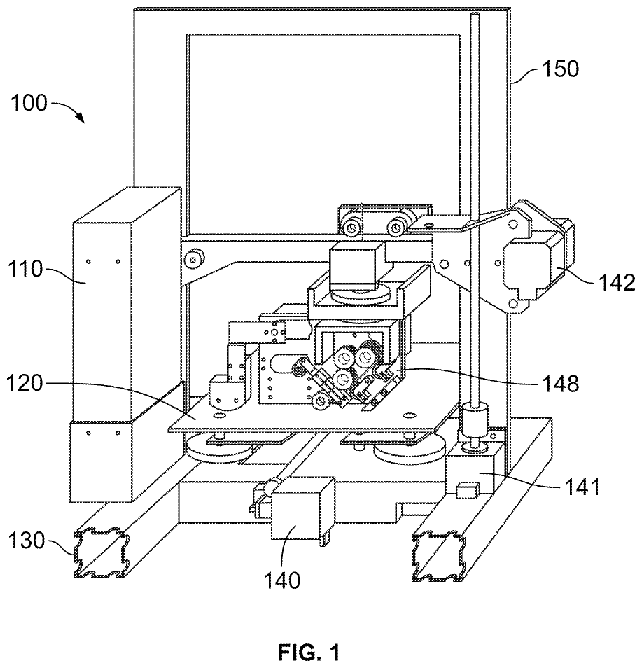

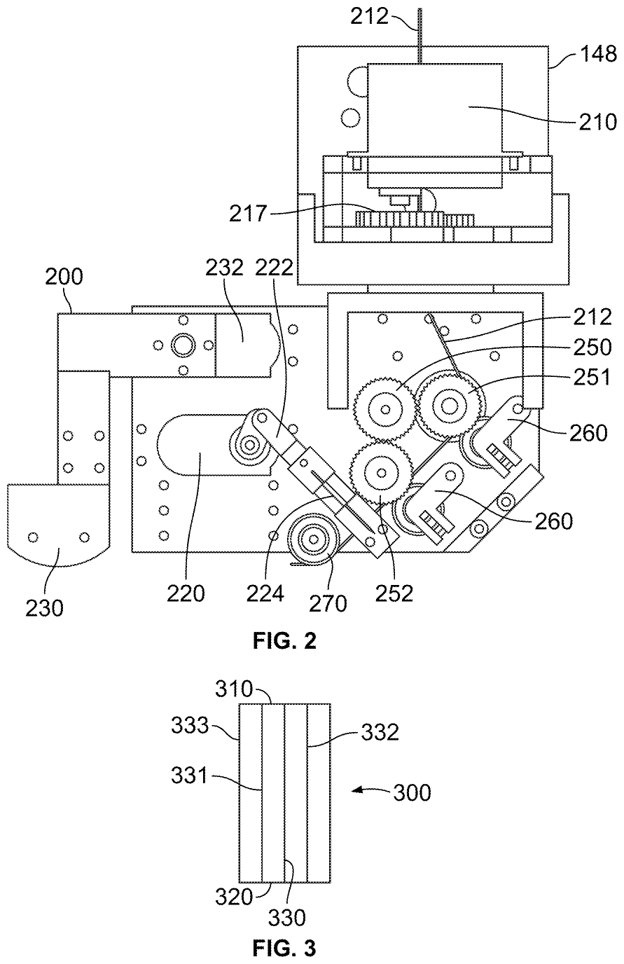

In one preferred embodiment, as shown in FIGS. 1 and 2, the present invention concerns a mechanical system, control system, and software. FDM printer 100 comprised of power source 110, print bed 120, printer base 130, Y-axis motor 140, Z-axis motor 141, -axis motor 142, extruder 148 and frame 150 as shown in FIG. 1.

Carbon fiber extruder 148 has three main functionalities, including extruding in the XY plane, which is necessary to print predetermined, complex structures. Extruder 200 is rotated by servo motor 210 and gears 217. Carbon fiber tape 212 is fed through the system by distribution gears 250-252, along with tensioner 260, feed carbon fiber tape to pavement wheel 270.

Because carbon fiber tape 212 is fed continuously in a spool, a mechanism is needed to cut the carbon fiber to change the printing direction or location. To overcome this problem, another embodiment of the present invention uses an additional servo motor 220 to cut carbon fiber tape 212. A connecting rod 222 is used to convert the rotation of the servo motor into linear motion of the cutting blade 224. Connecting rod 222 converts the rotation of the servo motor into linear motion of the cutting blade.

The carbon fiber tape is pre-impregnated with a heat-sensitive resin, which needs to be cured at high temperatures. Therefore, the present invention provides a heater 230 to heat and cure the carbon fiber tape after it has been laid down on the previous layer. A servo motor 232 is used to rotate the heater to the desired position to heat the pre-impregnated carbon fiber tape when needed.

The present invention provides a control system that is largely based on that of a regular FDM printer. The main difference is that three additional servo motors, a heater, and thermal couple are connected to enable the extruding, cutting, and heating mechanisms in the mechanical system.

In a preferred embodiment, the software used with the present invention is mostly the same as a regular FDM printer, including firmware and slicer. After the generation of G-code using a regular slicer, additional software may be used to scan the generated G-code to determine three things for each line of the G-code: the printing direction/orientation, whether a cut is needed at the end, and whether heating is needed. Then additional lines of G-code to control the servo motors may be inserted at the corresponding locations to complete the function. For example, M280 P1 S20 can be inserted to set the printing direction by controlling the first servo motor.

In use, the present invention concerns a method of 3D printing to create a predetermined structure from unbroken strands of carbon fibers. The method provides a mechanical system and control system. The mechanical system including an extruder that extrudes unbroken strands of carbon fiber in an XY plane.

As shown in FIG. 3, a segment 300 made from the embodiments of the present invention consist of a first cut end 310 that is spaced apart from a second cut end 320. The first end extruded before said second cut end.

The unbroken strands of carbon fiber 330-333 extend from the first cut end to the second cut end. Lastly, the control system is adapted to control the printing direction, orientation, whether a cut is needed at the end, and whether heating is needed.

While the foregoing written description enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above-described embodiments, methods, and examples, but by all embodiments and methods within the scope and spirit of the disclosure.

1. (canceled)

2. (canceled)

3. (canceled)

4. (canceled)

5. (canceled)

6. (canceled)

7. (canceled)

8. (canceled)

9. A method of 3D printing carbon fibers to create a predetermined structure made from unbroken stands of carbon fibers comprising the steps of:
providing a mechanical system and control system;
said mechanical system including an extruder that extrudes unbroken strands of carbon fiber in an XY plane;
said segments consist of a first cut end spaced apart from a second cut end;
said first end extruded before said second cut end;
said unbroken strands of carbon fiber extend from said first cut end to said second cut end; and
said control system is adapted to control the printing direction, orientation, whether a cut is needed at the end, and whether heating is needed.

10. The method of claim 9 wherein said extruder is rotatable and is able to extrude continuous carbon fibers while being rotated.

11. The method of claim 10 wherein said cutting mechanism includes a servo motor connected to a cutting blade.

12. The method of claim 11 wherein said cutting mechanism includes a connecting rod to convert the rotation of said servo motor into linear motion of said cutting blade.

13. The method of claim 11 further including a heater to heat and cure said carbon fiber.
